(19) United States
(12) Patent Application Publication
(10) Pub. No.: US 2024/0190052 A1
(43) Pub. Date: Jun. 13, 2024

(54) Novel foaming process for production of foam materials

(71) Applicant: Evonik Operations GmbH, Essen (DE)

(72) Inventors: Thomas Richter, Darmstadt (DE); Andreas Liebe, Darmstadt (DE); Christian Traßl, Warmensteinach (DE); Florian Becker, Darmstadt (DE); Vincent Ma Junyong, Darmstadt (DE)

(73) Assignee: Evonik Operations GmbH, Essen (DE)

(21) Appl. No.: 18/412,259

(22) Filed: Jan. 12, 2024

Related U.S. Application Data
(63) Continuation of application No. 17/310,059, filed on Jul. 14, 2021, now Pat. No. 11,904,514.

(30) Foreign Application Priority Data
Jan. 16, 2019 (EP) 19152178.0

(51) Int. Cl. B29C 44/34; B29C 35/08; B29K 105/04

(52) U.S. Cl. CPC B29C 44/3415; B29C 35/0805; B29C 2035/0855; B29K 2105/04

(57) ABSTRACT

A production process can produce foam materials from a polymer composition. This production process may involve preheating a polymer composition to be foamed. The preheated composition may then be foamed by a thermal process assisted by microwaves. The foaming may occur in an apparatus that has a heating device. The polymer composition may contain a blowing agent.

### FIELD OF THE INVENTION

The present invention relates to a novel production process for foam materials from polymer compositions, wherein this novel process comprises a process step of preheating in the foaming of polymers containing blowing agents and subsequent foaming by a thermal process assisted by microwaves.

### PRIOR ART

Foaming processes for polymers for producing (rigid) foams are common knowledge. Known processes include continuous extrusion processes in which polymers are melted in an extruder and loaded with blowing agents, in which case they foam as a result of the pressure drop on exit from the nozzle, bead foam processes in which blowing agent-containing polymer pellets are foamed in a mould by supplying energy (thermally, steam), batch processes in which polymers are loaded under pressure with CO₂ or N₂, for example, under supercritical conditions and foam in the event of a pressure drop, or else slabstock foam processes in which polymers containing blowing agents are softened by heating above the glass transition temperature in an oven and foam by virtue of the blowing agent present.

The abovementioned slabstock foam processes in which a polymer sheet containing blowing agents is thermally heated above the Tg of the polymer are used inter alia for the production of PMI- or PMMA-based rigid foams (DE2726259, DE1817156, EP3277748). One reason for the use is the good adjustability of the density of the foams obtained via the foaming temperature/foaming duration. Furthermore, the abovementioned rigid foams based on PMI or PMMA are not obtainable economically by other production processes since their high molecular weights, important for mechanical properties, mean that they are not producible by extrusion processes.

Microwave technologies find only very limited use in the production of foams. EP 0037470 describes, for example, the production of elastic melamine foams. This involves heating, and hence foaming and crosslinking, a liquid melamine-formaldehyde precondensate with the aid of microwave radiation.

EP 3277748 gives a superficial description that it is possible to foam blowing agent-containing PMMA cast polymers even with a combination of thermally supplied energy in conjunction with microwaves. But no more exact details are given as to the process parameters or the upstream preheating step.

The rigid foam blocks are preferably produced from polymer sheets obtained by a casting polymerization process in which blowing agent is added to the monomer solution before polymerization. In order to foam these blowing agent-containing polymer sheets, they must be heated above the boiling point/decomposition point of the blowing agents present and simultaneously above the glass transition temperature of the polymer. Purely thermal heating in an oven has the disadvantage that the energy input into the polymer takes place purely by convection and conduction of thermal energy. This process may take two to three hours since plastics are poor thermal conductors per se and the foam temperature in the core of the polymer sheets is thus achieved only slowly. Furthermore, the foaming polymer insulates itself with respect to the oven temperature.

### Problem

The problem addressed was that of developing an economically viable process for foaming (rigid) foams that simultaneously leads to a product having very homogeneous pore structure.

Particularly for the production of rigid foam blocks, such as PMI- and PMMA-based foams that cannot be produced by extrusion processes, for example, on account of their high molar masses of the matrix polymer, an economically viable foaming process was to be developed.

A further aim was to distinctly shorten the process for production of rigid foam sheets and hence to make the foaming process more economically viable.

Further problems not discussed explicitly at this point may be apparent hereinafter from the prior art, the description, the claims or working examples.

### Solution

The objects are achieved by a novel process for producing foams, characterized in that, in this process, polymer compositions containing a blowing agent are foamed in an apparatus, and in that the polymer compositions to be foamed are preheated prior to the foaming. Said apparatus has a thermal heating device for heating to an internal temperature of the apparatus Tₛ and at least one microwave source by means of which the polymer compositions are irradiated simultaneously.

The polymer composition is preferably a material that forms a rigid foam after foaming. This is more preferably P(M)I (poly(meth)acrylimide), PMMA, a methacrylate-based copolymer, PVC (polyvinyl chloride), PP (polypropylene), PU (a polyurethane), especially highly crosslinked PU, a polysulfone or a poly(ether)imide.

In the preheating step, the polymers to be foamed, prior to the foaming conducted in the apparatus, are preheated at a temperature Tᵥ between a minimum of 80° ° C. below and a maximum of 10° ° C. above the internal temperature of the apparatus Tₛ. Preferably, Tᵥ is at a minimum of 60° C., more preferably a minimum of 40° C., especially a minimum of 20° C., below the internal temperature of the apparatus. Also preferably, Tᵥ is not higher than Tₛ, and is more preferably at least 10° C. lower than Tₛ.

The preheating and the actual foaming can be effected in the same apparatus, for example in the form of an optional temperature change and a switch-on of the microwave sources after the preheating. However, preference is given to conducting the two steps in separate apparatuses. For instance, the preheating can be effected simultaneously in a large oven with multiple workpieces. Individual workpieces are then taken therefrom for the foaming.

It has been found to be particularly advantageous to conduct the preheating in such a way that the temperature differential thereafter between the coldest and hottest point within the polymer compositions after preheating is not greater than 15° C., preferably not greater than 10° ° C. Equally preferably, the preheated polymer composition is then sent directly to the foaming in the apparatus.

It is especially advantageous to preheat the polymer composition, prior to the foaming, to a preheating temperature Tᵥ above the glass transition temperature T_{g} of the polymer composition. Ideally, the polymer composition is elastic when the actual foaming is commenced.

For many materials, even those with a relatively high crystalline component, for example PP, in a simplified manner, a preheating temperature Tᵥ between 110 and 190° ° C. has been found to be favourable. In general, the preheating time is at least 60 min, preferably at least 100 min.

Preference is given to using microwave radiation having a frequency between 0.85 and 6.0 GHz. It has been found to be favourable to use polymer sheets having a thickness between 10 and 30 mm, preferably between 20 and 25 mm, as polymer composition.

The actual foaming can be effected, for example, within 2 to 30 min, preferably within 5 to 20 min, in the apparatus.

In a preferred embodiment of the present invention, the polymer composition is PMI. For this embodiment, the preheating temperature Tᵥ is preferably between 120 and 190° C. and the internal temperature of the apparatus Tₛ between 180 and 240° C.

In another preferred embodiment of the present invention, the polymer composition is PMMA or a methacrylate-based copolymer. For this embodiment, the preheating temperature Tᵥ is preferably between 110 and 140° ° C. and the internal temperature of the apparatus Tₛ between 120 and 190° C.

A major advantage of the process according to the invention is that it can be conducted in an environmentally benign manner and in very short cycle times and simultaneously in a material-conserving manner. In particular, by the process of the invention, surprisingly uniform pore sizes and pore size distributions are obtained throughout the foam part.

A further processible rigid foam is PVC foam. This rigid foam is universally known from fibre composite technology and sandwich production for wagon construction and the production of wind turbines and from boatbuilding. The finished foam sheets can be processed analogously to the PMI foam sheets.

The same applies to rigid PP foams. PP foams are especially known as insulation material, in transport containers and as sandwich material. PP foams can comprise fillers and are available commercially, mostly in a density range from 20 to 200 kg/m³.

Features of rigid PU foams, in comparison with flexible PU foams, are in turn a more closed pore structure and a higher degree of crosslinking. Rigid PU foams can also comprise relatively large amounts of inorganic filler materials.

The density of the rigid foam material can be selected relatively freely. Foams may be used, for example, in a density range from 25 to 220 kg/m³.

In principle, the workpieces of the invention made from a rigid foam are very widely usable.

1-10. (canceled)

11. A process for producing a foam, the process comprising:
preheating a polymer composition to be foamed, and foaming the polymer composition containing a blowing agent in an apparatus having a thermal heating device for heating to an internal temperature of the apparatus Tₛ and irradiating simultaneously the polymer composition by at least one microwave source of the apparatus,
wherein the polymer composition is preheated in the apparatus at a temperature between a minimum of 80° C. below and a maximum of 10° ° C. above the internal temperature of the apparatus Tₛ, and
wherein the temperature differential between a coldest point and a hottest point within the polymer composition after the preheating is not greater than 15ºC.

12. The process according to claim 11, wherein the polymer composition is a material that forms a rigid foam after the foaming.

13. The process according claim 11, wherein the polymer composition, prior to the foaming, is preheated to a preheating temperature Tᵥ above a glass transition temperature Tₛ of the polymer composition.

14. The process according to claim 11, wherein a preheating temperature Tᵥ is between 110 and 190° C., and a preheating time is at least 85 min.

15. The process according to claim 11, wherein microwave radiation from the at least one microwave source has a frequency between 0.85 and 6.0 GHz.

16. The process according to claim 11, wherein the polymer composition comprises PMI (polymethacrylimide), wherein a preheating temperature T_{V} is between 120 and 190° C., and wherein an internal temperature of the apparatus T_{S} is between 180 and 240° C.

17. The process according to claim 11, wherein the polymer composition comprises PMMA or methacrylate-based copolymer, wherein a preheating temperature T_{V} is between 110 and 140° C., and wherein an internal temperature of the apparatus T_{S} is between 120 and 190° C.

18. The process according to claim 12, wherein the rigid foam is selected from the group selecting of P(M)I (poly(meth)acrylimide), PMMA, a methacrylate-based copolymer, polyvinyl chloride (PVC), polypropylene (PP), polyurethane (PU), a polysulfone, and a poly(ether)imide.

19. The process according to claim 14, wherein the preheating time is at least 110 min.

20. The process according to claim 11, wherein a preheating time is at least 70 min.

21. The process according to claim 11, wherein a preheating time is at least 80 min.
